(19) United States
(12) Patent Application Publication
(10) Pub. No.: US 2026/0276152 A1
(43) Pub. Date: Sep. 17, 2026

(54) METHOD AND SYSTEM FOR PROVIDING MEDIUM

(71) Applicant: Linde GmbH, Pullach (DE)

(72) Inventors: Andreas JANZEN, Pullach (DE); Anton BALLA, Pullach (DE); Bernhard BECK, Pullach (DE); Michael WESTERMEIER, Pullach (DE); Michale CSAR, Pullach (DE); Simon SCHÄFER, Pullach (DE); Tanja HARTMANN, Pullach (DE)

(21) Appl. No.: 19/162,612

(22) PCT Filed: Mar. 5, 2024
(86) PCT No.: PCT/EP2024/025103

§ 371 Date: Sep. 5, 2025

(30) Foreign Application Priority Data
Mar. 10, 2023 (EP) 23020118.8

(51) Int. Cl. F17C 13/00

(52) U.S. Cl. CPC F17C 13/00; F17C 2221/012; F17C 2227/0341

(57) ABSTRACT

A method for providing a medium, in particular hydrogen, wherein the medium is fed from a first medium storage device via a plurality of supply paths to a second medium storage device, wherein the medium is fed from the second medium storage device to one or more dispensers for providing the medium, in particular for filling a vehicle, wherein medium is fed in each of the plurality of supply paths in each case by means of a conveying unit from the first medium storage device via a respective first heat exchanger to the second medium storage device, and wherein each of the first heat exchangers is supplied via a common first coolant storage device with a first, in particular liquid, cooling medium. The invention also relates to a system therefor, and to the use thereof.

The invention relates to a method for providing a medium, in particular hydrogen, and there in particular to heat management. The invention also relates to a corresponding system, in particular a hydrogen filling station, and to a use of such a system.

Hydrogen, which is used as fuel for vehicles, for example, can be provided via so-called hydrogen filling stations. At a hydrogen filling station, two system areas can typically be distinguished. The first system area concerns the compression of hydrogen, its storage, as well as its conditioning and cooling. The second system area comprises a hydrogen dispenser and the associated filling equipment, such as breakaway and filling couplings as well as the filling hose.

A particular challenge in such a hydrogen filling station, or other systems for providing media, is often heat management.

### DISCLOSURE OF THE INVENTION

This object is achieved by a method and a system for providing a medium, and to a use of the system, having the features of the independent claims. Preferred embodiments are the subject matter of the dependent claims and the following description.

### ADVANTAGES OF THE INVENTION

The invention relates to the provision of a medium, in particular hydrogen, as is the case, for example, at hydrogen filling stations. In the following, a method and a system for providing a medium will be described in detail. The invention will also be described primarily with reference to hydrogen as a medium using the example of a hydrogen filling station. However, it should be noted that the process and the system also apply to other media, in particular gases or (initially) liquefied gases. Oxygen or nitrogen, for example, come into consideration here, in particular their temperature control with further utilization of the heat energy released.

A basic structure of such a system is such that the system has a first medium storage device, e.g., a storage tank for liquefied medium or hydrogen, a second medium storage device, e.g., one or more high-pressure stores, and a dispenser. A conveying unit such as a pump, in particular a cryopump, can then be provided, by means of which the medium is supplied from the first medium storage device to the second medium storage device. From there, the medium can then be supplied to the dispenser in order to dispense the medium, or hydrogen, to a vehicle (or other consumer), for example during a filling process.

As already mentioned, heat management (or thermal management) is an important aspect for such a system and its operation, in particular in order to be able to operate the system in as efficient and energy-saving a manner as possible. The thermal management ensures, for example, that the medium, e.g., the compressed hydrogen, can be fed into the vehicles at a controlled temperature of, for example, down to −40° C. In addition, various components can be cooled as part of thermal management. The required cooling capacity is recovered in particular from the medium or hydrogen itself.

Hydrogen is usually stored in liquid form in the first medium storage device at a pressure of approximately 3 bar. However, under these conditions, hydrogen has a very low temperature of e.g., approximately −253° C. For media other than hydrogen, the exact conditions, such as temperature and pressure, may also be different. Before buffering in the second medium storage device, the medium, or hydrogen, must usually first be heated to a higher temperature, e.g., room temperature. For this purpose, a first heat exchanger (or heat transfer device), preferably also a second heat exchanger, can be provided via which the medium or the hydrogen is supplied from the first medium storage device to the second medium storage device by means of the conveying unit.

In the first heat exchanger, the medium is heated by a first coolant from a first coolant storage device (e.g., a coolant tank, a so-called cold coolant tank), in the case of hydrogen, for example, to approximately −90° C. As it flows through the first heat exchanger, the first coolant then cools, in this case, to approximately −43° C., for example, and thus recovers the cold thermal energy of the hydrogen for further internal use. In the second heat exchanger, the medium is heated by a second coolant from a second coolant storage device (e.g., a coolant tank, a so-called warm coolant tank), in the case of hydrogen e.g., to room temperature. In this case, further cold heat energy is recovered so that the second coolant storage device can be kept at approximately 20° C., for example. The second (or warm) coolant can be reused in the process to cool components such as the conveying unit, e.g., the for example electrically or hydraulically driven pump or cryopump (compressor). The first (or cold) coolant can be used to cool the then warm compressed hydrogen (or another medium) from the second medium storage device in the dispenser (or a fuel pump when filling a vehicle). For this purpose, a dispenser heat exchanger can be provided, e.g., as part of the dispenser.

The connection of the various media flows and the resulting recovery of the cold thermal energy enables a high overall thermal efficiency. In addition, there is no longer any need to install an additional cooling machine to cool the warm hydrogen to the desired filling temperature at the fuel pump. This increases the overall efficiency of the system, as power consumption is reduced.

However, the use of only one dispenser and only one pump in the system only allows a limited throughput of medium. Thus, in order to increase the throughput of such a system (e.g., hydrogen filling station), a plurality of conveying units can be used to supply the medium from the first medium storage device to the second medium storage device. For this purpose, a plurality of supply paths can be provided, each with one of the plurality of conveying units. In addition, a plurality of dispensers can be provided instead of just one, which can then be adequately supplied, in particular when there are multiple supply paths.

This is a multiple compression system operated in parallel that allows for high availability and a high degree of flexibility. However, the thermal management system described above is tailored to a single conveying unit; a simple multiple use of the described thermal management for each of the multiple supply paths will then generally allow the operation of the system, but leaves room for improvements in efficiency and can also lead to certain problems.

Against this background, it is proposed that a conveying unit such as a pump (e.g., a cryopump or a compressor) and a first heat exchanger, in one embodiment also a second heat exchanger, are provided for each of the multiple supply paths. However, for the plurality of supply paths, (only) one common first coolant storage device with a first coolant is provided, wherein each of the first heat exchangers is supplied with the first coolant via the first coolant storage device. In the case of second heat exchangers, in addition (only) one common second coolant storage device with a second coolant is provided for the plurality of supply paths, wherein each of the second heat exchangers is supplied with the second coolant via the second coolant storage device.

The first coolant storage device can then continue to supply one or each of the plurality of dispenser heat exchangers with the first coolant. The second coolant from the second cooling device can further be used to cool one or more other components such as the conveying units.

The use of the common (or combined) first coolant storage device and in particular also of the common (or combined) second coolant storage device for all individual supply paths with the conveying units ensures that all individual pumps can be thermally connected to one another without any problems. At the same time, the effort for mechanical interconnection is significantly reduced compared to the use of a plurality of individual first or second coolant storage devices (e.g., coolant tanks), since no valve blocks are required. In addition, there is no need for a complex overfill monitoring and protection design with complex control software. All these measures ensure that every dispenser connected to the system is available at all times and independently of the operation of an individual conveying unit.

The use of the common first coolant storage device minimizes the ambient heat input into the first coolant circuit with the first coolant, since the total surface area to the environment is significantly reduced by using the common first coolant storage device instead of a plurality of small, interconnected coolant storage devices or containers. This increases the overall thermal efficiency of the system. Any remaining, small heat input can be compensated by the cooling device mentioned, e.g., an integrated small cooling unit. This ensures that the common first coolant storage device can be kept at a constant temperature, regardless of the operation of the conveying units. This enables the medium to be provided as needed, e.g., by filling. On the other hand, the overall consumption of medium, in particular liquefied hydrogen, is reduced since the recurring operation of the pumps is no longer required to maintain the temperature of the first (cold) coolant. This increases the overall performance and efficiency of the system.

The use of the common first coolant storage device and also the common second coolant storage device also reduces the total area of the system, e.g., the space required by the hydrogen filling station, in particular compared to the use of a plurality of individual first or second coolant storage devices.

The first coolant and/or the second coolant are preferably each a liquid coolant, i.e., a cooling liquid. The first and second heat exchangers are then configured to transfer heat energy between the medium (e.g., hydrogen) and the liquid first and second coolant, respectively. In cryogenics, so-called finned heat exchangers (or generally air-to-medium heat exchangers) can often be used, which evaporate or heat the cryogenic medium by heat input from the environment. Due to the limited air-side heat transfer, these typically have to be very large. In addition, the fins can freeze, which usually results in a redundant design of such fin heat exchangers. The use of liquid coolant or appropriately configured heat exchangers, i.e., so-called coolant-to-medium heat exchangers, improves heat transfer compared to the use of air (or other gaseous coolant) and at the same time eliminates the need for a redundant design.

The invention is schematically represented in the drawing using an exemplary embodiment and is described below with reference to the drawing.

### BRIEF DESCRIPTION OF THE DRAWING

FIG. 1 schematically shows a system according to the invention in a preferred embodiment.

### DETAILED DESCRIPTION OF THE DRAWING

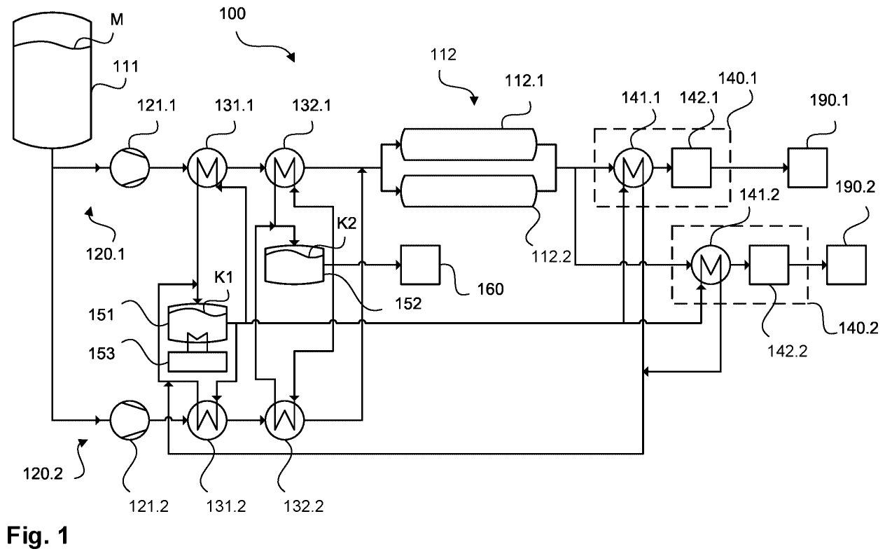

FIG. 1 schematically shows a system 100 according to the invention in a preferred embodiment, in which a method according to the invention can also be carried out. The system 100 is used to provide a medium, e.g., hydrogen. For example, the facility is a hydrogen filling station.

The system comprises a first medium storage device 111, a second medium storage device 112 and, for example, two dispensers 140.1, 140.2. The first medium storage device 111 can in particular be a storage tank for liquefied medium M such as liquefied hydrogen or other liquefied gas. Hydrogen can be stored there, for example, at about 3 bar and −253° C. The second medium storage device 112 can be a high-pressure storage device; it can for example have one or more high-pressure accumulators, in particular for gaseous medium, e.g., hydrogen; for example, the second medium storage device 112 comprises two high-pressure accumulators 112.1, 112.2, which can be operated in parallel.

Each of the exemplary two dispensers 140.1, 140.2 is supplied with medium, e.g., hydrogen, from the second medium storage device 112, i.e., the hydrogen is supplied to the dispensers from the second medium storage device 112. The dispenser 140.1 has for example a dispenser heat exchanger 141.1 and a filling interface 142.1. The dispenser heat exchanger 141.1 can cool the medium to a desired or required temperature, such as that required for a filling process. For example, a connection to a vehicle 190.1 to be filled or to its tank can be established via the filling interface 142.1. Of course, the dispenser 140.1 can have additional components that are necessary for a filling process, but which are not relevant here. The dispenser 140.2 has for example a dispenser heat exchanger 141.2 and a filling interface 142.2 in order to be able to fill a vehicle 190.2. The functioning of the dispenser 140.2 here can correspond to that of the dispenser 140.1. The system 100 is thus configured to supply the medium M from the second medium storage device 112 to each of the plurality of dispensers 140.1, 140.2. Of course, further dispensers of this type (or of a different type) could also be provided, which could then also be supplied with medium from the second medium storage device 112 and could be provided for filling a vehicle. And of course, as necessary, only one of the two dispensers shown may be used, e.g., if one of the dispensers is defective, needs maintenance or should not be used for other reasons. Likewise, if there are more than two dispensers any subset of them can be used.

Furthermore, the system 100 comprises a plurality of supply paths, for example two supply paths 120.1, 120.2. A supply path can be understood in particular as a separate connection between the first medium storage device 111 and the second medium storage device 112, via which medium can be supplied from the first medium storage device 111 to the second medium storage device 112. Each supply path can be operated independently of the others.

For each of the multiple supply paths, the system 100 has a conveying unit, e.g., a pump, in particular a cryopump, a first heat exchanger and, in one embodiment, also a second heat exchanger. In the example shown, the supply path 120.1 has a conveying unit 121.1, a first heat exchanger 131.1 and a second heat exchanger 132.1. By means of the conveying unit 121.1, medium M can be supplied from the first medium storage device 111 via the first heat exchanger 131.1, and subsequently via the second heat exchanger 132.1, to the second medium storage device 112. Furthermore, in the example shown the supply path 120.2 has a conveying unit 121.2, a first heat exchanger 131.2 and a second heat exchanger 132.2. By means of the conveying unit 121.2, medium M can be supplied from the first medium storage device 111 via the first heat exchanger 131.2, and subsequently via the second heat exchanger 132.2, to the second medium storage device 112. Both supply paths 120.1, 120.2 can therefore be constructed in a similar way and can also be used in parallel and in a similar way. Of course, further supply paths of this type could also be provided, which could then also be similar and parallel to the supply paths shown.

The system 100 is configured to supply the medium M from the first medium storage device 111 to the second medium storage device 112 via each of the plurality of supply paths 120.1, 120.2, as described. Of course, as necessary, only one of the two supply paths shown may be used, e.g., if one of the supply paths is defective, needs maintenance or should not be used for other reasons. Likewise, if there are more than two supply paths any subset of them can be used.

Furthermore, the system 100 has a common first coolant storage device 151 with a first coolant K1 for the plurality of supply paths, here the two supply paths 120.1, 120.2. The first coolant storage device 112 can be for example a coolant tank. The system 100 is configured to supply each of the first heat exchangers, in this case the first heat exchangers 131.1, 131.2, with the first coolant K1 via the first coolant storage device 151. This is to be understood in particular as meaning that the first coolant K1 is conducted through each of the first heat exchangers 131.1, 131.2 in order to heat the medium M, which is also conducted or guided through each of the first heat exchangers 131.1, 131.2, to a desired temperature, as described above. Hydrogen as a medium can be heated to approx. −90° C., for example, whereby the first coolant K1 cools down to approx. −43° C. As usual in a heat exchanger, a transfer of heat takes place. As mentioned above, a liquid first coolant is preferred. For example, mixtures of water and antifreeze agents such as glycol (e.g., ethylene glycol, propylene glycol, and the like) or salts (e.g., potassium formate or similar) are suitable.

In one embodiment, the system 100 is also configured to supply each of the plurality of dispenser heat exchangers, here the dispenser heat exchangers 141.1, 141.2, with the first coolant K1 via the first coolant storage device 151. This is also to be understood in particular as meaning that the first coolant K1 is conducted through each of the dispenser heat exchangers 141.1, 141.2 in order to heat the medium M, which is also conducted or guided through each of the dispenser heat exchangers 141.1, 141.2, to a desired temperature for the filling, as described above. Hydrogen as a medium can be cooled here to approximately −40° C., for example. As usual in a heat exchanger, a transfer of heat takes place.

In one embodiment, the system 100 also has a cooling device 153 by which the first coolant K1 in the first coolant storage device 151 is cooled. The cooling device 153 can for example be an integrated small cooling unit with which any remaining small heat input, e.g., from the environment, can be compensated for.

Furthermore, in one embodiment, the system 100 has a common second coolant storage device 152 with a second coolant K2 for the plurality of supply paths, here the two supply paths 120.1, 120.2. The second coolant storage device 152 can be for example a coolant tank. The system 100 is configured to supply each of the second heat exchangers, in this case the second heat exchangers 132.1, 132.2, with the second coolant K2 via the second coolant storage device 152. This is to be understood in particular as meaning that the second coolant K2 is conducted through each of the second heat exchangers 132.1, 132.2 in order to heat the medium M, which is also conducted or guided through each of the second heat exchangers 132.1, 132.2, to a desired temperature, as described above. Hydrogen as a medium can be heated here to, for example, approximately room temperature, and the second coolant K2 can be kept at approximately 20° C. As usual in a heat exchanger, a transfer of heat takes place. As already mentioned, a liquid second coolant is preferred. For example, mixtures of water and antifreeze agents such as glycol (e.g., ethylene glycol, propylene glycol, and the like) or salts (e.g., potassium formate or similar) are suitable.

For both the first and second coolant, it is particularly important that so-called refrigerants are used as the coolant, which have the lowest possible lower operating temperature.

In one embodiment, the system 100 is also configured to use the second coolant K2 from the second cooling device 152 to cool one or more further components; such components are designated here by 160 as representative examples. Thus, as the components e.g., the conveying units 121.1, 121.2 or parts thereof (e.g., electronics, hydraulics) can be efficiently cooled in this way.

1. A method for providing a medium, in particular hydrogen, wherein the medium is supplied from a first medium storage device via a plurality of supply paths to a second medium storage device, wherein the medium is supplied from the second medium storage device to one or more dispensers for providing the medium, in particular for filling a vehicle,
wherein in each of the plurality of supply paths, medium is supplied from the first medium storage device via a corresponding first heat exchanger to the second medium storage device by means of a conveying unit, and
wherein each of the first heat exchangers is supplied with a first, in particular liquid, coolant via a common first coolant storage device.

2. The method according to claim 1, wherein the medium is supplied from the second medium storage device via a dispenser heat exchanger to the one or via, in each case, one of a plurality of dispenser heat exchangers to the plurality of dispensers for provision.

3. The method according to claim 2, wherein the one or each of the plurality of dispenser heat exchangers is further supplied with the first coolant via the first coolant storage device.

4. The method according to claim 1, wherein the first coolant in the first coolant storage device is further cooled by a cooling device.

5. The method according to claim 1, wherein in each of the plurality of supply paths, medium is supplied by means of the conveying unit from the first medium storage device via the corresponding first heat exchanger and subsequently a corresponding second heat exchanger to the second medium storage device, and
wherein each of the second heat exchangers is supplied with a second, in particular liquid, coolant (K) via a common second coolant storage device.

6. The method according to claim 5, wherein the second coolant from the second cooling device is further used to cool one or more further components, in particular the conveying units.

7. The method according to claim 5, wherein the first coolant is used at a lower temperature than the second coolant.

8. The method according to claim 1, wherein the medium is stored in the first storage device in liquefied form.

9. The method according to claim 1, wherein hydrogen is used as medium.

10. A system for providing a medium, in particular hydrogen, wherein the system has a first medium storage device, a second medium storage device, and one or more dispensers,
wherein the system comprises a plurality of supply paths and for each of the plurality of supply paths has a corresponding conveying unit and a first heat exchanger,
wherein the system is configured to supply the medium from the first medium storage device via each of the plurality of supply paths, by means of the conveying unit in each case, via the first heat exchanger to the second medium storage device,
wherein the system is configured to supply the medium from the second medium storage device to one or each of the plurality of dispensers for provision, in particular for filling a vehicle,
wherein the system has a common first coolant storage device with a first, in particular liquid, coolant for the plurality of supply paths, and wherein the system is configured to supply each of the first heat exchangers with the first coolant via the first coolant storage device.

11. The system according to claim 10, which further has a second heat exchanger for each of the plurality of supply paths,
wherein the system is configured to supply the medium from the first medium storage device via each of the plurality of supply paths by means of the conveying unit via the first heat exchanger and subsequently the second heat exchanger to the second medium storage device,
wherein the system has a common second coolant storage device with a second, in particular liquid, coolant for the plurality of supply paths, and wherein the system is configured to supply each of the second heat exchangers with the second coolant via the second coolant storage device.

12. The system according to claim 10, which is configured to carry out a method for providing a medium, in particular hydrogen, wherein the medium is supplied from a first medium storage device via a plurality of supply paths to a second medium storage device, wherein the medium is supplied from the second medium storage device to one or more dispensers for providing the medium, in particular for filling a vehicle,
wherein in each of the plurality of supply paths, medium is supplied from the first medium storage device via a corresponding first heat exchanger to the second medium storage device by means of a conveying unit, and
wherein each of the first heat exchangers is supplied with a first, in particular liquid, coolant via a common first coolant storage device.

13. The system according to claim 10, which is designed as a hydrogen filling station.

14. A use of a system according to claim 10 for filling a vehicle with hydrogen as a medium.
